(19) United States
(12) Patent Application Publication
(10) Pub. No.: US 2024/0251256 A1
(43) Pub. Date: Jul. 25, 2024

(54) MILLIMETER WAVE COMMUNICATIONS NETWORKS FOR FIXED WIRELESS ACCESS

(71) Applicant: Pivotal Commware, Inc., Bothell, WA (US)

(72) Inventors: Mersad Cavcic, Kirkland, WA (US); Brett Daniel Mills-Meiner, Seattle, WA (US)

(21) Appl. No.: 18/374,539

(22) Filed: Sep. 28, 2023

Related U.S. Application Data
(60) Provisional application No. 63/411,038, filed on Sep. 28, 2022.

(51) Int. Cl. H04W 24/02; H04W 64/00; H04W 84/04

(52) U.S. Cl. CPC H04W 24/02; H04W 64/003; H04W 84/047

(57) ABSTRACT

Qualification for fixed wireless access with millimeter waves can be qualified along a 2D outline or 3D face of a building. Qualification can depend on the window type, e.g., whether the window is low-e, single-paned, double-paned, and/or recessed. Qualification can also depend on the type of CPE to be installed on or near each window to provide the fixed wireless access within the premises. Eligible locations for repeaters can be identified, e.g., in comm zones for existing poles or on new poles to be installed in rights-of-way, and recommendations can be made for efficient installation of new repeaters to optimize wireless coverage.

### CROSS-REFERENCE TO RELATED APPLICATION

This application is a Utility Patent application based on previously filed U.S. Provisional Patent Application No. 63/411,038 filed on Sep. 28, 2022. The benefit of the filing date of this provisional application is hereby claimed under 35 U.S.C. § 119(e) and the contents of this provisional application is herein incorporated by reference in its entirety.

### TECHNICAL FIELD

The invention relates generally to improving coverage for fixed wireless access in millimeter-wave communications networks.

### BACKGROUND

The high bandwidth that mmWave 5G provides is being used by carriers to break in to the fixed broadband home internet market—known as Fixed Wireless Access (FWA). When planning and qualifying homes for FWA, carriers currently use legacy tools that are built for planning lower-frequency mobility networks. These tools neither model at a high-enough resolution to accurately predict mmWave coverage, nor do they contemplate many of the important differences between mobility networks and FWA networks. These tools especially do not contemplate many of the realities for qualifying FWA in large multifamily dwelling units (MDUs), where part of the building may be covered, while other parts are not, which leads to unsatisfactory network performance and high cancellation rates. Legacy tools typically only consider the signal strength of the signals incident on the building when making coverage qualification determinations. They do not consider factors such as the building materials, angle of incidence of the signal onto the building, window type, or whether the windows are recessed from the face of the building—all factors that are vital to the actual performance of FWA networks. Instead of modeling these features, carriers are forced to add a large “shadow fading” factor to each of their predictions. Additionally, carriers use a binary approach to qualifying buildings, and do not contemplate the idea that part of a building may be qualified while others are not (or how some parts of the building may need different equipment to provide FWA). For large MDUs with many individual units, carriers need to know which units have coverage and which do not to provide FWA to the correct people.

### BRIEF DESCRIPTION OF THE DRAWINGS

FIG. 1 depicts an example of 2D building outline qualification.

FIGS. 2 and 3 depict an example of 3D building face qualification.

FIGS. 4 and 5 depict an example of single family unit (SFU) qualification.

FIG. 6 depicts a process flow for wireless coverage qualification.

FIG. 7 shows an exemplary computer system.

### DESCRIPTION OF VARIOUS EMBODIMENTS OF THE INVENTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Similarly, the phrase “in another embodiment” as used herein does not necessarily refer to a different embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments of the invention are directed to a method, apparatus, or system that provides a suite of devices and software tools executing on a computing device, e.g., a distributed cloud computing platform, a desktop computer, a notebook computer or a mobile device. One or more of the various embodiments of the devices and tools enable a user, such as a carrier, to extend millimeter wave coverage for wireless communication networks while reducing costs and optimizing coverage for different environments.

A wireless communication network may include wireless base stations, outdoor network repeaters, and indoor subscriber repeaters and/or customer premises equipment (CPEs) for fixed wireless access (FWA). Wireless base stations may include, for example, gNodeB (gNB) base stations for 5G communications at FR1 or FR2 frequency bands. FR1 includes frequency bands below about 7 GHz. FR2 includes frequency bands above about 24 GHz, also referred to as millimeter wave (mmW) frequencies. Wireless base stations can also include base stations for 6G or higher generation wireless communications, or other wireless protocols. Throughout this disclosure, the use of the term gNB may refer to base stations generally without being limited to 5G base stations.

Outdoor network repeaters, such as the Pivot 5G, are devices that can be installed on a post, pole, building corner, or other structure and configured to receive signals from a wireless base station (or from another repeater) and rebroadcast the received signals. For two-way communication, the open-air repeater can also receive signals and rebroadcast them to the wireless base station. In some approaches, the open-air repeater includes a donor antenna that can be adjusted to point a beam at the relevant wireless base station (or other repeater), and a service antenna providing a beam that covers a rebroadcast service area. The donor antenna and/or the service antenna can be electronically adjustable antennas such as holographic beamforming antennas. Various open-air repeater structures are described, for example, in U.S. Pat. No. 10,425,905, which is herein incorporated by reference.

Indoor subscriber repeaters, such as the Echo 5G, are devices that can be installed on a window and configured to receive signals from a wireless base station (or from another repeater) and rebroadcast the received signals to premises behind the window. For two-way communication, the window repeater can also receive signals from the premises behind the window and rebroadcast them to a wireless base station (or another repeater) outside the window. The window repeater can be entirely mounted on the outside of the window, or entirely mounted on the inside of the window, or it can have exterior and interior portions that adjoin exterior and interior surfaces of the window. In some approaches, the window repeater includes a donor antenna that can be adjusted to point a beam at the relevant wireless base station (or other repeater) outside of the premises, and a service antenna providing a beam that covers the interior of the premises. The donor antenna and/or the service antenna can be electronically adjustable antennas such as holographic beamforming antennas. Various window repeater structures are described, for example, in U.S. Pat. No. 10,425,905, which is herein incorporated by reference.

Customer premises equipment (CPEs) are devices that can provide fixed wireless access (FWA) for interior premises such as the interior of a dwelling unit in a multiple dwelling unit (MDU), or the interior of a dwelling unit in a single dwelling unit or single family unit (SFU). Throughout this disclosure, an MDU will be understood to include buildings that provide more than one dwelling space, e.g., an apartment building, a condominium, a mixed-use building, etc. The dwellings can be residential, or commercial, or a combination. Similarly, throughout this disclosure, an SFU will be understood to include buildings that provide one dwelling space, e.g., a house or a stand-alone commercial property. Customer premises equipment can include a receive antenna that receives signals from a base station or repeater within a vicinity of the building; for two-way communication, the customer premises equipment can also include a transmit antenna that transmits signals to the base station or repeater; or a single antenna can serve for both transmit and receive functions. The customer premises equipment can provide internet access within the interior premises, for example, by including WiFi and/or ethernet modules. In some approaches, the CPE can be a single unit, e.g., that is mounted on a window of a MDU. In other approaches, the CPE can include an exterior antenna module, e.g., for wireless communication with the base station or repeater, and an interior module, e.g., for providing WiFi or ethernet access within the premises.

Various embodiments include a software application, hereinafter referred to as a wireless network modelling application, for modelling and optimizing the placement of the various devices constituting the wireless communications network. In one or more of the various embodiments, this wireless network modelling application may orchestrate the other tools and devices by allowing carriers to plan their mmWave networks and quantify both the physical and economic impact each component has on the network. Various wireless network modelling applications are described, for example, in U.S. Patent Application Publication No. 2022/0232396, which is herein incorporated by reference.

The wireless network modelling application can model any set of network elements, including base stations, repeaters, and CPEs, and allows users to explore the tradeoffs different network deployment strategies. The wireless network modelling application can ingest high resolution GIS data and utilize propagation models such as 3GPP propagation models. The application can ingest the network elements that have been deployed within a region as well as the physical layout of that region. The tool can then identify buildings that likely-subscribers occupy and determines the coverage level within and just outside the building, thus allowing carriers to qualify them for FWA based on minimum signal-level, antenna beamwidth, and placement requirements of different customer premise equipment (CPE). By ingesting utility poles, lampposts, strands, and public building corners that a carrier may have access to, the tool can recommend placement and orientation of new network elements (including, base stations, repeaters, CPEs, or other equipment in use by the carrier) to reach a given target coverage level. Furthermore, the tool can dynamically ingest and re-optimize based on updated real estate requirements, new target metrics, and newly deployed equipment. Recommendations can be based on efficiency per incremental coverage basis, and the tool allows users to update and refine their efficiency models. The tool can allow carriers to explore different hypothetical deployment scenarios so they can uncover the most effective deployment strategy for a specific region. By tracking the incremental coverage of each network element, a carrier will be able to select efficient coverage targets for each region. Furthermore, the tool's ability to ingest specifications for any network element allows carriers to compare the efficiency features of all available equipment—including, e.g., base stations, repeaters, and CPEs.

### Overview

In some approaches, a “qualification outline” is created for buildings within a coverage area to display which portions of the face of a building are qualified for FWA at a fixed height, where the locations are based on a combination of imagery and AI-assisted edge detection on a Digital Surface Model.

In some approaches, outlines are color-coded to represent different standards of qualification which can depend on factors such as minimum signal strength, minimum SINR, and/or angle sweep thresholds (along vertical and/or horizontal axes) for a window-mounted CPE (customer premises equipment). For example, a first color (e.g., green) can indicate portions of the outline with a high level of qualification, a second color (e.g., yellow) can indicate portions of the outline with a moderate level of qualification, and a third color (e.g., red) can indicate portions of the outline with a low level of qualification. While this particular example describes three colors indicating three degrees of qualification, in other approaches, the outline can be characterized according to any number of degrees of qualification. Medium or low levels of qualification might indicate that those particular portions of the building are not qualified for fixed wireless access, or that those particular portions of the building might require more advanced CPEs or more advanced installation methods.

Window-mounted CPEs can include devices that receive millimeter waves from outside the window and rebroadcast those millimeter waves inside the premises. Window-mounted CPEs can also include devices that receive millimeter waves from outside the window and then, within the premises, provide the data encoded within those millimeter wave signals using other wired or wireless data protocols such as WiFi or ethernet.

In some approaches, outlines are generated for different window types (low-e glass, double pane glass, recessed windows, etc.).

In some approaches, for each location along the face of a building, a tracing can be provided from the location to the predicted dominant transmitter (e.g., a gNodeB or repeater) for that location, and metrics can be provided at each point along the face of the building to see the incremental coverage due to each transmitter.

In some approaches, the antenna pattern of a window-mounted CPE can be modeled with an assumed orientation relative to the window (as the CPE used by carriers is typically mounted parallel to the window). The antenna pattern can be based on factors including the particular type of CPE and the particular type of window on which the CPE is placed (e.g., low-e glass, single pane glass, double-pane glass). For recessed windows, the antenna pattern can also take into account the limited field of view of the CPE due to the geometrical constraint of the window recess.

In some approaches, the qualification can be viewed in 3D, where modeled receiver locations are determined by a combination of an edge detection algorithm and image-generated building outlines. The receiver locations can be placed such that each one represents an equal amount of surface area on the face of the building, thus allowing a calculation of percentage coverage on the face of a building. The qualification can be visualized on top of a 3D digital twin of the area encapsulating the target building and the transmitters. Areas along the face of the building can be qualified for FWA in the same way as is done for 2D. In some approaches, window locations can be extracted, and then qualifications can be provided for individual windows of a building. In some approaches, the qualification can be used to identify which specific units within an MDU are qualified for fixed wireless access.

Qualifications can be provided according to different qualification standards and different types of CPE—this allows the carrier to select the CPE that is most appropriate for a given coverage profile, e.g., to choose the least expensive CPE given the signal present.

In some approaches, the Fresnel zone can be analyzed between a given transmitter (e.g., a base station such as a gNodeB, or a previous repeater in a two-hop repeater scenario) and each potential location for placement of a repeater, such as comm-zone AI-extracted utility pole/street light locations and eligible building corners. This Fresnel zone analysis can qualify potential locations by quantifying the amount of any blockage within the Fresnel zone between the transmitter and the potential repeater location. Maximum emission power at each site can then be estimated by applying pathloss models to the above analysis.

In some approaches, eligible sites can be augmented with locations that are enabled for “two-hop” configuration, e.g., where one repeater provides service to a second repeater that is unreachable by a gNodeB alone, accounting for gain, EIRP, SINR, and/or Noise Figure.

In some approaches, for each auto-qualified repeater location, a cost-optimized design can be created to cover maximum square footage (or incremental windows covered) on the face of a building for minimum cost.

In areas where right-of-way to construct new poles is known, this area can be defined as well as the additional cost required to construct new poles. Suggestions can be provided for areas within these rights-of-way in which new pole construction would be economical to maximize incremental coverage. This can be extended, for example, to optimize on a metric such as percentage increase in confidence that an area is covered times area per unit cost required, accounting for average CPE cost, repeater cost, installation all-in cost, and new pole cost. In some approaches, a database can be assembled and consulted with various local cost considerations such as specific building rules and municipal rules (e.g., for cities that require a power meter for each newly-constructed pole). In these approaches, the suggestions can take into account these local cost considerations as well.

### Example 1: 2D Building Outline Qualification

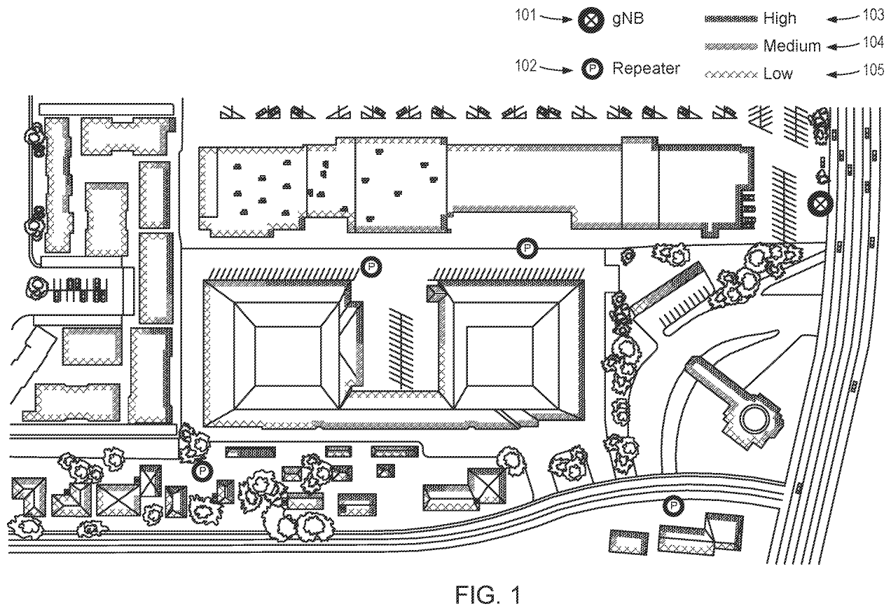

With reference now to FIG. 1, an illustrative scenario is depicted for wireless coverage qualification for one or more building outlines. The figure shows a view from above of a coverage area that includes several MDUs and several SFUs. Wireless service is provided to the area by base stations 101 and repeaters 102. A qualification outline is created for the buildings to display which portions of the building outlines are qualified for fixed wireless access (FWA) at a fixed height.

In this illustrative scenario, the depicted outlines can be based on a combination of imagery and AI-assisted edge detection on a Digital Surface Model. To estimate wireless coverage by the base stations 101 and repeaters 102, a propagation model such as a 3GPP propagation model is applied with ingested high-resolution GIS data, including locations of structures, terrain, foliage, etc. that affect wireless signal propagation. The outlines are then coded to represent different standards of qualification. The qualification can depend on factors such as minimum signal strength, minimum SINR, and/or angle sweep thresholds (along vertical and/or horizontal axes) for a window-mounted CPE (customer premises equipment). In this example, dark-shaded portions 103 of the outlines indicate portions with a high level of qualification; light-shaded portions 104 of the outline indicate portions of the outline with a moderate level of qualification; and cross-hatched portions 105 of the outline indicate portions with a low level of qualification.

In some approaches, the qualification can depend on the type of window on the building. For example, low-e glass windows, single-paned glass windows, and double-paned glass windows can have different transmission characteristics and this can be incorporated into the wireless coverage qualification, e.g., for a scenario with a CPE is to be installed on the inside surface of a window. In addition to a dependency on window type, the transmission characteristics can also depend on angle of incidence for the wireless communication signals received at a particular location along the building outline from a base station or repeater. Alternatively or additionally, if the windows are recessed, this restricts the angle of incidence due to the obstruction presented by the walls of the recess.

Alternatively or additionally, the qualification can depend on the type of CPE. For example, the gain of the CPE antenna may depend on the angle of incidence of the wireless communications signals received by a CPE at a particular location along the building outline from a base station or repeater. Some CPEs may have a fixed antenna pattern, while other CPEs may have an adjustable beam pattern, and the angular range of beam adjustability can be incorporated into the wireless coverage qualification for a particular posture (orientation) of the CPE. In some scenarios, the posture of the CPE can be inferred, e.g., if the CPE is to be mounted on a window with a known orientation.

In some approaches, the MDU building outline qualification can be used to determine service quality for a particular dwelling within the MDU. For example, if a particular portion of the building outline is associated with a particular dwelling, that portion of the outline can be used to assess a service quality for that particular dwelling, e.g., based on the highest level of qualification along that particular portion of the outline. The qualification along that particular portion of the outline can also be used to recommend a preferred location for a CPE. For example, if the particular portion of the outline encompasses two windows of the particular dwelling, where the first window has a higher qualification level and the second window has a lower qualification level, installation in the first window can be recommended.

In some approaches, a wireless network modelling application can recommend placements of the base stations and/or repeaters to provide wireless coverage to a selected building or neighborhood. A user of the wireless network modelling application can then view the wireless coverage as a 2D building outline qualification as in FIG. 1. Alternatively or additionally, the user can add or remove base stations or repeaters to see how the building outline qualification is affected by re-running the propagation model for the new configuration. In some approaches, new locations for repeaters can be selected from suitable locations such as comm-zones on existing street light poles or utility poles, or from strands (e.g., between two utility poles) that are suitable for strand-mounting a repeater. If there is not a convenient existing pole or strand, rights-of-way can be identified where it might be possible to install a new pole or strand to host the repeater.

### Example 2: 3D Building Face Qualification

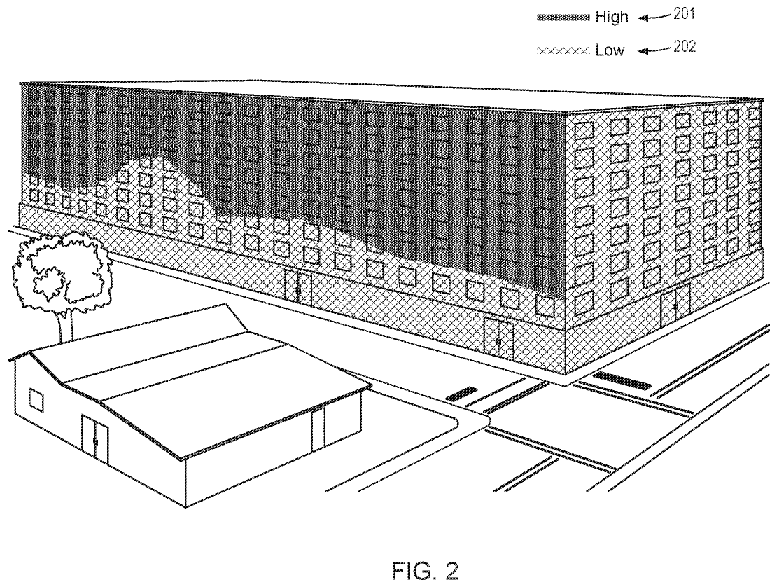

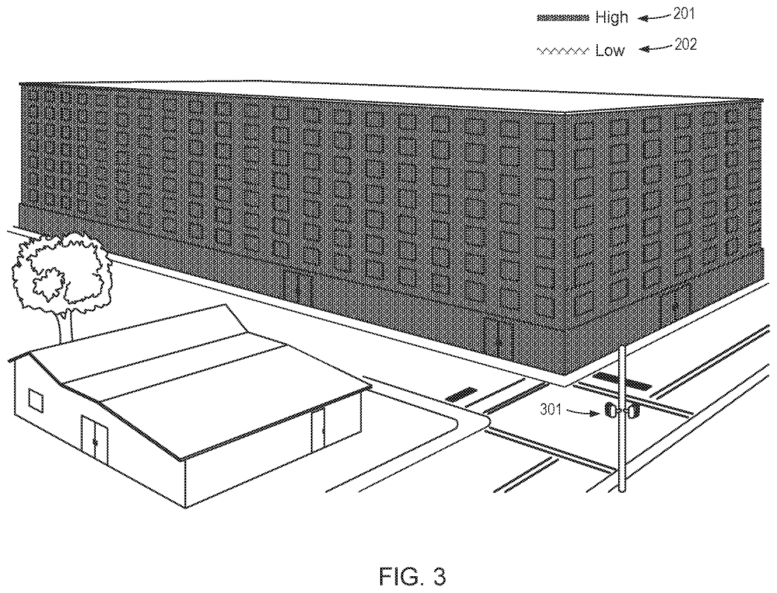

With reference now to FIGS. 2 and 3, an illustrative scenario is depicted for wireless qualification for a building viewed in three dimensions. The figures show a 3D view of a large MDU with adjacent structures and foliage. In FIG. 2, wireless service is provided to the MDU by a base station out of figure at left. In FIG. 3, wireless service is provided by the base station with the addition of a repeater 301 catacorner to the MDU.

In this scenario, the qualification can be viewed in 3D, where modeled receiver (potential CPE) locations are determined by a combination of an edge detection algorithm and image-generated building outlines. The receiver locations can be placed such that each one represents an equal amount of surface area on the face of the building, thus allowing a calculation of percentage coverage on the face of a building. The qualification can be visualized on top of a 3D digital twin of the area encapsulating the target building and the transmitters. Areas along the face of the building can be qualified for FWA in the same way as is done for 2D. In some approaches, window locations can be extracted, and then qualifications can be provided for individual windows of a building. In some approaches, the qualification can be used to identify which specific units within an MDU are qualified for fixed wireless access; and for units with multiple windows, which window might be preferred for installation of a CPE.

In FIG. 2, with wireless service provided to the MDU only by a single base station out of figure at left, only upper floor windows on the left face of the building have a high qualification level 201. Lower floor windows on the left face of the building have a low qualification level 202 because line of sight to the base station is obstructed by intervening structures and foliage. The entire right face of the building also has a low qualification level 202 because it faces away from the base station. By comparison, in FIG. 3, adding the repeater 301 catacorner to the MDU and re-running the propagation model for the new configuration then shows that the entire left and right faces of the MDU are given a high qualification level 201.

### Example 3: Single Family Unit (SFU) Qualification

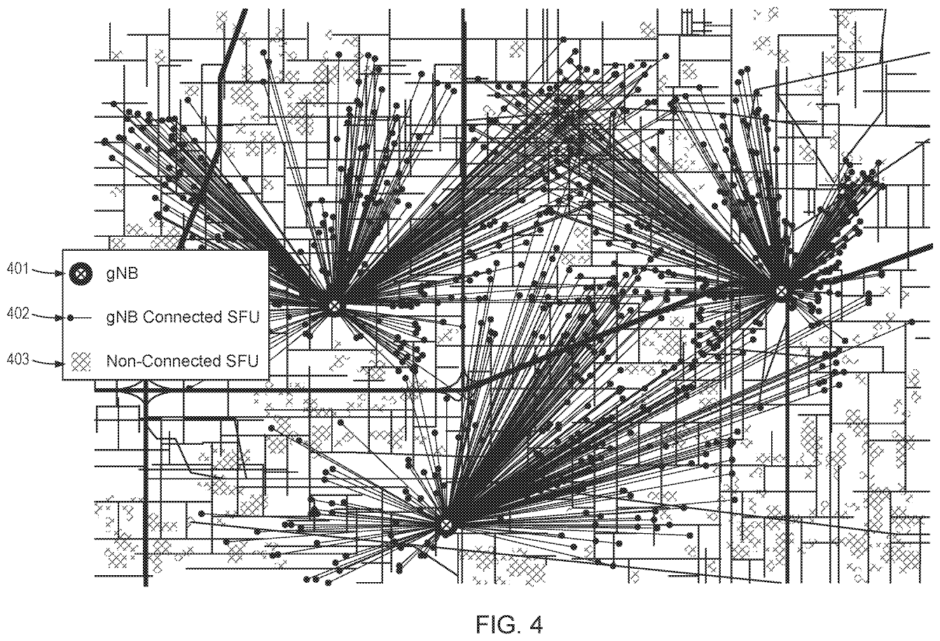

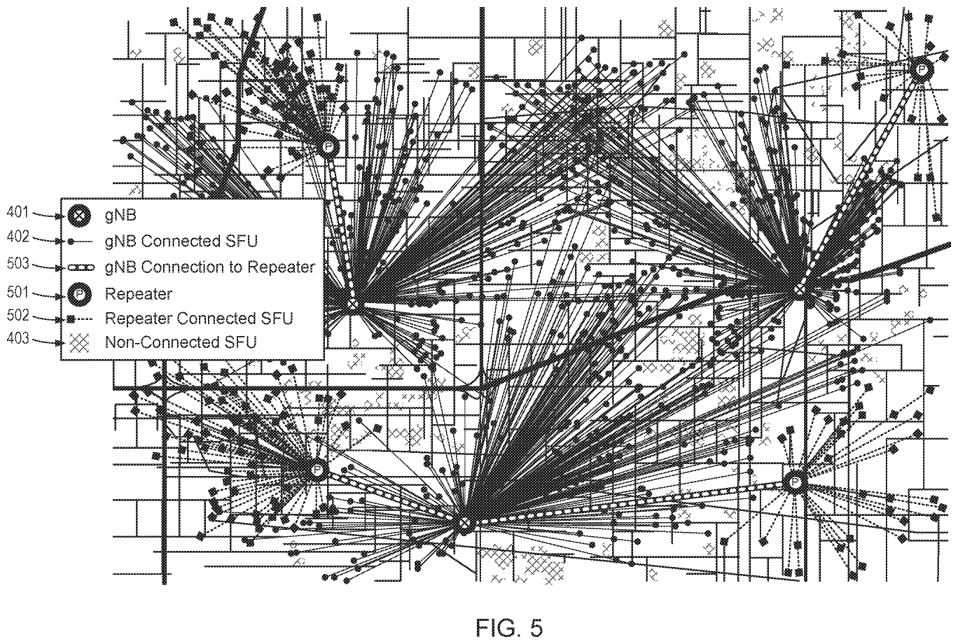

With reference now to FIGS. 4 and 5, an illustrative scenario is depicted for wireless coverage qualification for a neighborhood of single family units (SFUs). In FIG. 4, wireless service is provided to the area by base stations 401. In FIG. 5, wireless service is provided to the area by base stations 401 with the addition of repeaters 501.

In FIG. 4, the solid circles 402 represent SFUs with a high qualification level for wireless service, while the cross-hatched areas 403 represent SFUs with a low qualification level for wireless service. For the houses 402 with a high qualification level, the solid lines represent lines of sight from the houses 402 to the base stations 401 providing wireless service for that location. As above, to determine the qualification levels, a propagation model such as a 3GPP propagation model is applied with ingested high-resolution GIS data, including locations of structures, terrain, foliage, etc. that affect wireless signal propagation. In some approaches, for each house, the qualification level may be assessed for several features of the house, such as windows, corners, or rooftop features such as rooftop facets, ridges, etc.; and then an overall service quality for the dwelling can be determined for the dwelling, e.g., based on the highest level of qualification among the several features.

In FIG. 5, by comparison, the addition of the repeaters 501 provides a high qualification level for additional houses 502 (black squares) that previously had low qualification levels. In this scenario, the dashed lines represent lines of sight from the houses 502 to the repeaters 501 providing wireless service for that location. The figure also indicates how each repeater 501 is associated (heavy dashed lines 503) with a base station 401.

### Process Flows

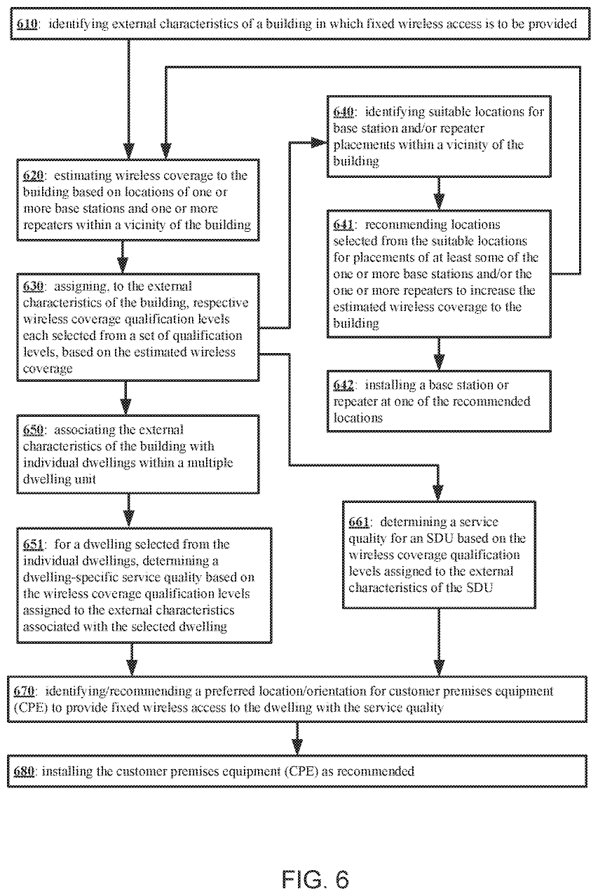

With reference now to FIG. 6, an illustrative embodiment is depicted as a process flow diagram. The process 600 includes operation 610—identifying external characteristics of a building in which fixed wireless access is to be provided. For example, 2D outlines of building can be identified as in FIG. 1 based on a combination of image detection and AI-assisted edge detection on a Digital Surface Model. As another example, 3D faces of a building such as an MDU can be identified as in FIGS. 2 and 3 based on a combination of an edge detection algorithm and image-generated building outlines. As another example, SFUs can be identified within a neighborhood as in FIGS. 4 and 5.

The process further includes operation 620—estimating wireless coverage to the building based on locations of one or more base stations and one or more repeaters within a vicinity of the building. For example, for a given configuration of base stations and repeaters, a propagation model such as a 3GPP propagation model can be applied with ingested high-resolution GIS data, including locations of structures, terrain, foliage, etc. that affect wireless signal propagation.

The process further includes operation 630—assigning, to the external characteristics of the building, respective wireless coverage qualification levels each selected from a set of qualification levels, based on the estimated wireless coverage. For example, as in FIG. 1, portions of a 2D outline of a building can be qualified has having high qualification level 103, a medium qualification level 104, or a low qualification level 105. As another example, as in FIGS. 2 and 3, portions of 3D faces of a building can be qualified as having a high qualification level 201 or a low qualification level 202. In some approaches, the portions of the 3D faces of the building can be portions of equal area that span the 3D faces of the building. In other approaches, the portions of the 3D faces of the building can correspond to windows of the building.

In some approaches, the process includes operations 640—identifying suitable locations for base station and/or repeater placements within a vicinity of the building; and 641—recommending locations selected from the suitable locations for placements of at least some of the one or more base stations and/or the one or more repeaters to increase the estimated wireless coverage to the building. For example, operation 640 can include identifying comm-zones on existing street light poles or utility poles suitable for pole-mount, or existing strands suitable for strand-mount, or rights-of-way in which new poles or strands could be installed. Operation 641 then includes recommending locations selected from these suitable locations, e.g., by re-running a 3GPP propagation model for the new configuration of base stations and repeaters with the additions at the recommended locations. The arrow leading from operation 641 to operation 620 indicates that this can be an iterative process. Thus, for example, FIGS. 2 and 3 show the wireless coverage qualification levels for 3D faces of a building before and after the addition of repeater 301, and FIGS. 4 and 5 show the wireless coverage qualification levels for SFUs before and after the addition of repeaters 501.

In some approaches, based on the recommending of operation 641, the process includes operation 642—installing a base station or repeater at one of the recommended locations. For example, a base station or repeater can be installed on an existing pole or strand as recommended, or the new pole or strand can be installed and a base station or repeater can be installed on the new pole or strand. The recommending can include recommending how to orient the base station or repeater during installation.

In scenarios involving a multiple dwelling unit (MDU), the process can include operations 650 associating the external characteristics of the building with individual dwellings within a multiple dwelling unit; and 651—for a dwelling selected from the individual dwellings, determining a dwelling-specific service quality based on the wireless coverage qualification levels assigned to the external characteristics associated with the selected dwelling. For example, for a 2D outline of an MDU as in FIG. 1, a particular portion of the building outline can be associated with a particular dwelling, and that portion of the outline can be used to assess a service quality for that particular dwelling, e.g., based on the highest level of qualification along that particular portion of the outline. As another example, for 3D faces of an MDU as in FIG. 2, a particular portion of the building face (such as one or more windows) can be associated with a particular dwelling, and that portion of the face can be used to assess a service quality for that particular dwelling, e.g., based on the highest level of qualification for that particular portion of the outline (such as the highest of the qualification levels for each of the one or more windows within that particular portion).

Alternatively, in scenarios involving a single dwelling unit (SDU), the process can include operation 661—determining a service quality for an SDU based on the wireless coverage qualification levels assigned to the external characteristics of the SDU. For example, for each SDU within a neighborhood as in FIGS. 4 and 5, qualification level may be assessed for several features of the house, such as windows, corners, or rooftop features such as rooftop facets, ridges, etc.; and then an overall service quality for the dwelling can be determined for the dwelling, e.g., based on the highest level of qualification among the several features.

Based on the operations 650 and 651 for an MDU, or operation 661 for an SDU, the process can further include operation 670—identifying/recommending a preferred location/orientation for customer premises equipment (CPE) to provide fixed wireless access to the dwelling with the service quality. For example, if a particular portion of a 2D outline of an MDU as in FIG. 1 corresponds to a particular dwelling, it can be recommended that the CPE be installed at the location of highest qualification level along that particular portion of the outline. As another example, if a particular portion of a 3D face of an MDU as in FIG. 2 corresponds to a particular dwelling, it can be recommended that the CPE be installed at the location of highest qualification level within that particular portion of the face (e.g., at a particular window of a particular dwelling having multiple windows). The recommending can also include recommending how to orient the CPE for best alignment of the CPE with a line of sight to the repeater or base station to provide wireless service for that CPE (e.g., how to mechanically adjust the azimuth of the CPE to point towards the repeater or base station).

In some approaches, based on the recommending of operation 670, the process includes operation 680—installing the customer premises equipment (CPE) as recommended. For example, the CPE can be installed in or on a window as recommended, or on another building feature such as a building corner or rooftop feature, and in some approaches the CPE can be mechanically oriented as recommended (e.g., by adjusting the azimuth to point towards the repeater or base station, or to point as nearly as possible towards the repeater or base station).

### Illustrative Computation Environment

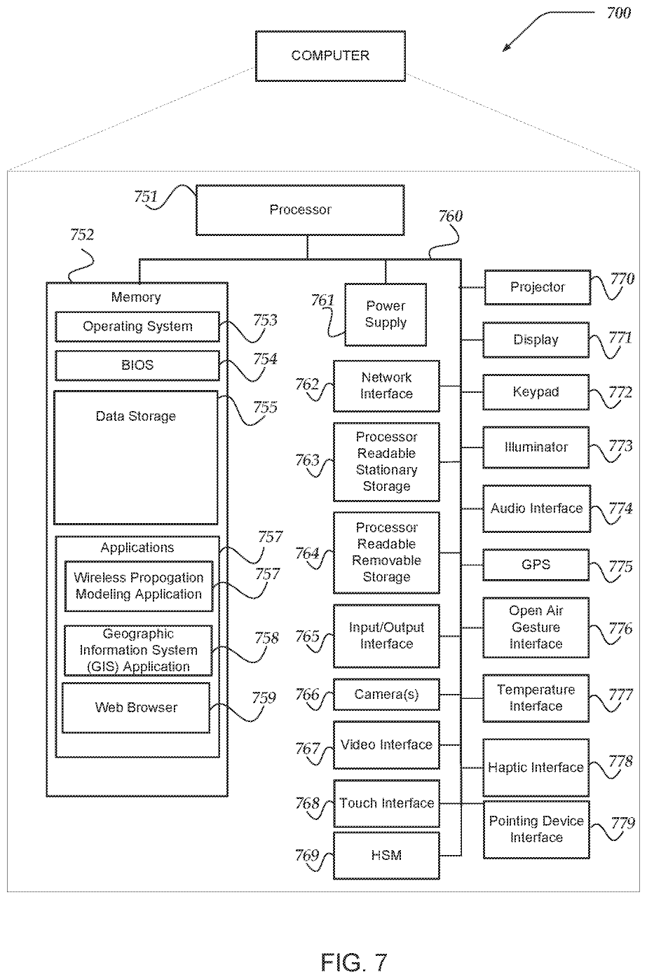

FIG. 7 shows one embodiment of computer 750 that may include many more, or less, components than those shown. In one or more embodiments, the operation and/or configuration of computer 750 may be included in a distributed cloud computing platform, a remote computer or remote computing system, a local computer or local computing system, a desktop computer, a notebook computer or a mobile device.

Computer 750 may include processor 751 in communication with memory 752 via bus 760. Computer 750 may also include power supply 761, network interface 762, audio interface 774, display 771, keypad 772, illuminator 773, video interface 767, input/output interface 765, haptic interface 778, global positioning systems (GPS) receiver 775, open air gesture interface 776, temperature interface 777, camera(s) 767, projector 770, pointing device interface 779, processor-readable stationary storage device 763, and processor-readable removable storage device 764. Computer 750 may optionally communicate with a wireless base station (not shown), a wireless repeater device (not shown) or directly with another computer. Power supply 761 may provide power to computer 750. A rechargeable or non-rechargeable battery may be used to provide power. The power may also be provided by an external power source, such as an AC adapter or a powered docking cradle that supplements or recharges the battery.

Network interface 762 includes circuitry for coupling computer 750 to one or more networks, and it is constructed for use with one or more wired and/or wireless communication protocols and technologies. Examples of various generations (e.g., third (3G), fourth (4G), or fifth (5G) of communication protocols and/or technologies may include, but are not limited to, Global System for Mobile communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000 (CDMA2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), time division multiple access (TDMA), Orthogonal frequency-division multiplexing (OFDM), ultra-wide band (UWB), Wireless Application Protocol (WAP), 5G New Radio (5G NR), 5G Technical Forum (5G TF), 5G Special Interest Group (5G SIG), Narrow Band Internet of Things (NB IoT), user datagram protocol (UDP), transmission control protocol/Internet protocol (TCP/IP), various portions of the Open Systems Interconnection (OSI) model protocols, session initiated protocol/real-time transport protocol (SIP/RTP), short message service (SMS), multimedia messaging service (MMS), or various ones of a variety of other communication protocols and/or technologies.

Audio interface 774 may be arranged to produce and receive audio signals such as the sound of a human voice. For example, audio interface 774 may be coupled to a speaker and microphone (not shown) to enable telecommunication with others or generate an audio acknowledgement for some action. A microphone in audio interface 774 can also be used for input to or control of computer 750, e.g., using voice recognition, detecting touch based on sound, and the like.

Display 771 may be a liquid crystal display (LCD), gas plasma, electronic ink, light emitting diode (LED), Organic LED (OLED) or any other type of light reflective or light transmissive display that can be used with a computer. Display 771 may also include a touch interface 668 arranged to receive input from an object such as a stylus or a digit from a human hand, and may use resistive, capacitive, surface acoustic wave (SAW), infrared, radar, or other technologies to sense touch or gestures.

Projector 770 may be a remote handheld projector or an integrated projector that is capable of projecting an image on a remote wall or any other reflective object such as a remote screen.

Video interface 767 may be arranged to capture video images, such as a still photo, a video segment, an infrared video, or the like. For example, video interface 767 may be coupled to a digital video camera, a web-camera, or the like. Video interface 767 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 772 may comprise any input device arranged to receive input from a user. For example, keypad 772 may include a push button numeric dial, or a keyboard. Keypad 772 may also include command buttons that are associated with selecting and sending images.

Illuminator 773 may provide a status indication or provide light. Illuminator 773 may remain active for specific periods of time or in response to event messages. For example, when illuminator 773 is active, it may backlight the buttons on keypad 772 and stay on while the computer is powered. Also, illuminator 773 may backlight these buttons in various patterns when particular actions are performed, such as dialing another computer. Illuminator 773 may also enable light sources positioned within a transparent or translucent case of the computer to illuminate in response to actions.

Further, computer 750 may also comprise hardware security module (HSM) 669 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 669 may be a stand-alone computer, in other cases, HSM 769 may be arranged as a hardware card that may be added to a computer.

Computer 750 may also comprise input/output interface 765 for communicating with external peripheral devices or other computers such as other computers and network computers. The peripheral devices may include an audio headset, virtual reality headsets, display screen glasses, remote speaker system, remote speaker and microphone system, and the like. Input/output interface 665 can utilize one or more technologies, such as Universal Serial Bus (USB), Infrared, WiFi, WiMax, Bluetooth™, and the like.

Input/output interface 765 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to computer 750.

Haptic interface 778 may be arranged to provide tactile feedback to a user of the computer. For example, the haptic interface 778 may be employed to vibrate computer 750 in a particular way when another user of a computer is calling. Temperature interface 777 may be used to provide a temperature measurement input or a temperature changing output to a user of computer 750. Open air gesture interface 776 may sense physical gestures of a user of computer 750, for example, by using single or stereo video cameras, radar, a gyroscopic sensor inside a computer held or worn by the user, or the like. One or more cameras 766 may be used by an application to employ facial recognition methods to identify a user, track the user's physical eye movements, or take pictures (images) or videos.

GPS device 775 can determine the physical coordinates of computer 750 on the surface of the Earth, which typically outputs a location as latitude and longitude values. GPS device 775 can also employ other geo-positioning mechanisms, including, but not limited to, triangulation, assisted GPS (AGPS), Enhanced Observed Time Difference (E-OTD), Cell Identifier (CI), Service Area Identifier (SAI) Tracking Area Identifier (TAI), Enhanced Timing Advance (ETA), Base Station Subsystem (BSS), or the like, to further determine the physical location of computer 750 on the surface of the Earth. It is understood that GPS device 775 can employ a gyroscope to determine an orientation and/or an accelerometer to determine movement of the computer 750. In one or more embodiment, however, computer 750 may, through other components, provide other information that may be employed to determine a physical location of the computer, including for example, a Media Access Control (MAC) address, IP address, and the like.

Human interface components can be peripheral devices that are physically separate from computer 650, allowing for remote input or output to computer 750. For example, information routed as described here through human interface components such as display 771 or keypad 772 can instead be routed through network interface 762 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™ Zigbee™ and the like. One non-limiting example of a computer with such peripheral human interface components is a wearable computer, which might include a remote pico projector along with one or more cameras that remotely communicate with a separately located computer to sense a user's gestures toward portions of an image projected by the pico projector onto a reflected surface such as a wall or the user's hand.

Computer 750 may include wireless propagation modeling application 757 (WPM) that may be configured to remotely model propagation of wireless signals at one or more locations in one or more wireless networks. For example, WPM may model propagation of wireless signals according to a 3GPP or similar wireless signal propagation model, which may account for, e.g., attenuation due to distance, attenuation due to intervening foliage, etc. WPM 757 may employ geographical information provided by Geographic Information System (GIS) application 758 regarding the one or more locations. In one or more embodiments, WPM 758 may utilize an IoT network to communicate with the at least a portion of the elements in the one or more wireless networks, including the plurality of wireless signal repeater devices.

Computer 750 may include web browser application 759 that is configured to receive and to send web pages, web-based messages, graphics, text, multimedia, and the like. For example, the web browser application may provide graphical depictions of coverages areas as in FIGS. 1-5. The computer's browser application may employ virtually any programming language, including a wireless application protocol messages (WAP), and the like. In one or more embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 752 may include Random Access Memory (RAM), Read Only Memory (ROM), or other types of memory. Memory 752 illustrates an example of computer-readable storage medium (devices) for storage of information such as computer-readable instructions, data structures, program modules or other data. Memory 752 may store BIOS 754 for controlling low-level operation of computer 750. The memory may also store operating system 753 for controlling the operation of computer 750. It will be appreciated that this component may include a general-purpose operating system such as a version of UNIX, or LINUX™, or a specialized computer communication operating system such as Windows Phone™, Apple iOS™ or the Symbian® operating system. The operating system may include, or interface with a Java virtual machine module that enables control of hardware components or operating system operations via Java application programs.

Memory 752 may further include one or more data storage 755, which can be utilized by computer 750 to store, among other things, applications 756 or other data. For example, data storage 755 may also be employed to store information that describes various capabilities of computer 750. The information may then be provided to another device or computer based on any of a variety of methods, including being sent as part of a header during a communication, sent upon request, or the like. Data storage 755 may also be employed to store social networking information including address books, buddy lists, aliases, user profile information, or the like. Data storage 755 may further include program code, data, algorithms, and the like, for use by a processor, such as processor 751 to execute and perform actions. In one embodiment, at least some of data storage 755 might also be stored on another component of computer 750, including, but not limited to, non-transitory processor-readable removable storage device 764, processor-readable stationary storage device 763, or even external to the computer.

Applications 756 may include computer executable instructions which, when executed by computer 750, transmit, receive, or otherwise process instructions and data. Applications 756 may include, for example, WPM application 757, GIS application 758, web browser 759, or the like. Computers may be arranged to exchange communications, such as, queries, searches, messages, notification messages, event messages, alerts, performance metrics, log data, API calls, or the like, combination thereof, with application servers or network monitoring computers.

Other examples of application programs include calendars, search programs, email applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), computer 750 may include one or more embedded logic hardware devices instead of CPUs, such as, an Application Specific Integrated Circuit (ASIC), Field Programmable Gate Array (FPGA), Programmable Array Logic (PAL), or the like, or combination thereof. The embedded logic hardware devices may directly execute embedded logic to perform actions. Also, in one or more embodiments (not shown in the figures), computer 750 may include one or more hardware microcontrollers instead of CPUs. In one or more embodiments, the microcontrollers may directly execute their own embedded logic to perform actions and access their own internal memory and their own external Input and Output Interfaces (e.g., hardware pins or wireless transceivers) to perform actions, such as System On a Chip (SOC), or the like.

Also, in one or more embodiments, a system may comprise one or more processors and one or more memories that store instructions. Further, the one or more processors that execute the instructions may be configured to carry out any of the methods disclosed herein including, but not limited to, the claimed embodiments of Claims 1-25.

Additionally, in one or more embodiments, a computer-readable non-transitory medium may be arranged to store instructions. Further, one or more processors that execute the instructions may be configured to carry out any of the methods disclosed herein including, but not limited to, the claimed embodiments of Claims 1-25.

1. A method, comprising:
identifying external characteristics of a building in which fixed wireless access is to be provided;
estimating wireless coverage to the building based on locations of one or more base stations and one or more repeaters within a vicinity of the building; and
assigning, to the external characteristics of the building, respective wireless coverage qualification levels each selected from a set of qualification levels, based on the estimated wireless coverage,
wherein the identifying includes identifying a two-dimensional outline of the building; and
wherein the assigning includes assigning the respective wireless coverage qualification levels to respective portions of the two-dimensional outline based on the estimated wireless coverage.

2. The method of claim 1, wherein the estimated wireless coverage is estimated wireless coverage for 5G or higher generation wireless communications.

3. The method of claim 1, wherein the estimated wireless coverage is estimated wireless coverage for millimeter-wave wireless communications.

4. (canceled)

5. (canceled)

6. (canceled)

7. (canceled)

8. The method of claim 1, wherein the building is a multiple dwelling unit (MDU).

9. The method of claim 8, further comprising:
associating the external characteristics of the building with individual dwellings within the multiple dwelling unit; and
for a dwelling selected from the individual dwellings, determining a dwelling-specific service quality based on the wireless coverage qualification levels assigned to the external characteristics associated with the selected dwelling.

10. The method of claim 9, wherein the external characteristics associated with the selected dwelling include one or more windows associated with the selected dwelling.

11. The method of claim 10, wherein the determining of the dwelling-specific service quality includes identifying a preferred window selected from the one or more windows to provide fixed wireless access to the selected dwelling with the dwelling-specific service quality.

12. The method of claim 11, further comprising:
recommending installation of customer premises equipment (CPE) at the preferred window.

13. The method of claim 1, wherein the building is a single dwelling unit (SDU).

14. The method of claim 13, further comprising:
determining a service quality for the SDU based on the wireless coverage qualification levels assigned to the external characteristics of the SDU.

15. The method of claim 14, wherein the external characteristics include one or more SDU features selected from one or more windows, one or more building corners, and one or more rooftop features.

16. The method of claim 15, wherein the determining of the service quality includes identifying a preferred SDU feature selected from the one or more SDU features to provide fixed wireless access to the SDU with the service quality.

17. The method of claim 16, further comprising:
recommending installation of customer premises equipment (CPE) at the preferred SDU feature.

18. The method of claim 1, wherein the assigning of the wireless coverage qualification levels includes assigning based on a selected type of customer premises equipment (CPE) to provide the fixed wireless access.

19. The method of claim 18, wherein the assigning of the wireless coverage qualification levels includes assigning based on angle of incidence for wireless communication signals from the one or more base stations and/or the one or more repeaters on customer premises equipment installed or installable on or in the building.

20. The method of claim 1, wherein the assigning of the wireless coverage qualification levels includes assigning based on a selected type of window for the building.

21. The method of claim 20, wherein the type of window is selected from a low-e glass window, a recessed low-e glass window, a single-paned glass window, a recessed single-paned glass window, a double-paned glass window, or a recessed double-paned glass window.

22. The method of claim 20, wherein the assigning of the wireless coverage qualification levels includes assigning based on angle of incidence for wireless communication signals from the one or more base stations and/or the one or more repeaters on windows of the building.

23. The method of claim 1, further comprising:
identifying suitable locations for base station and/or repeater placements within a vicinity of the building; and
recommending locations selected from the suitable locations for placements of at least some of the one or more base stations and/or the one or more repeaters to increase the estimated wireless coverage to the building.

24. The method of claim 23, wherein the suitable locations include one or more locations selected from comm-zones on existing street light poles or utility poles, rights-of-way in which new poles could be installed, and strands.

25. The method of claim 23, wherein the recommending includes recommending locations to cost optimize an incremental increase in wireless coverage based on one or more of a cost to install a new base station, a cost to install a new repeater, and a cost to install a new pole or strand.

26. (canceled)

27. (canceled)

28. A method, comprising: installing customer premises equipment according to the recommending of claim 12.

29. A method, comprising: installing a base station or repeater at one of the recommended locations of claim 23.
